(19) United States
(12) Patent Application Publication
(10) Pub. No.: US 2014/0258398 A1
(43) Pub. Date: Sep. 11, 2014

(54) System and Method for Automatic Context Detection, Sharing, and Storage in Real-Time Communication Systems

(71) Applicant: FUTUREWEI TECHNOLOGIES, INC., Plano, TX (US)

(72) Inventors: Francis Kurupacheril, Cupertino, CA (US); Paul Fullarton, Sunnyvale, CA (US); Dennis Episkopos, Westminster, CO (US)

(73) Assignee: FUTUREWEI TECHNOLOGIES, INC., Plano, TX (US)

(21) Appl. No.: 13/789,487

(22) Filed: Mar. 7, 2013

(51) Int. Cl. H04L 29/08

(52) U.S. Cl. CPC H04L 67/22
USPC 709/204

(57) ABSTRACT

A method embodiment includes creating, by a processor, a number of contexts for a first user, creating a list of potential contexts based on the number of contexts when the first user and a second user engage in a real-time communication, displaying the list of potential contexts to the first user.

### TECHNICAL FIELD

The present invention relates generally to systems and methods for unified communication systems, and, in particular embodiments, to a system and method for automatic context detection, sharing, and storage in real-time communication systems.

### BACKGROUND

Generally, unified communications (UC) refers to the combination of real-time communication systems (e.g., instant messaging, telephony, video conferencing, and the like) and non-real-time time communication systems (e.g., voicemail, e-mail, short message services, and the like). UC systems allow a user to consolidate communications from various sources, improving organizational efficiency and productivity. However, while existing systems may allow a user to monitor and categorize the subject matter of past communications, the ability to automatically detect the subject matter of a communication in real-time and share the relevant subject matter is not currently available.

### SUMMARY OF THE INVENTION

These and other problems are generally solved or circumvented, and technical advantages are generally achieved, by preferred embodiments of the present invention which provide a system and method for automatic context detection, sharing, and storage in real-time communication systems.

In accordance with an embodiment, a method for real-time communications includes creating, by a processor, a plurality of contexts for a first user, creating a list of potential contexts in accordance with the plurality of contexts when the first user and a second user engage in a real-time communication, displaying the list of potential contexts to the first user.

In accordance with another embodiment, a method for real-time communications includes creating, by a processor, a datastore of contexts for a first user, wherein each context in the datastore includes information on communications, activities, or a combination thereof related to the context, information on one or more objects related to the context, and information on other users related to the context, generating a list of possible contexts when the first user and the second user engage in a real-time communication based on the database of contexts, displaying the list of possible contexts to the first user, determining an applicable context for real-time communication from the list of possible contexts, and sharing the applicable context with the first and the second user.

In accordance with yet another embodiment, a unified communications (UC) device includes a processor, and a computer readable storage medium storing programming for execution by the processor, the programming including instructions to create a datastore of contexts for a first user, generate a list of possible contexts when the first user and the second user engage in a real-time communication based on the datastore of contexts, display the list of possible contexts to the first user, determine an applicable context for the real-time communication from the list of possible contexts, and share the applicable context with the first and the second user.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a block diagram illustrating a unified communications system in accordance with various embodiments;

FIG. 2 is a block diagram illustrating a settings menu for a unified communications system in accordance with various embodiments;

FIGS. 3A-3C are diagrams illustrating various exemplary screens during a real-time communication in accordance with various embodiments;

FIG. 4 is a flow chart illustrating various process steps for unified communications in accordance with various embodiments;

FIGS. 5A-5B are flow charts illustrating various process steps for real-time communications in accordance with various embodiments; and

FIG. 6 is a block diagram illustrating a computing platform that may be used for implementing, for example, the devices and methods described herein, in accordance with an embodiment.

### DETAILED DESCRIPTION OF ILLUSTRATIVE EMBODIMENTS

The making and using of embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Various embodiments will be described with respect to a specific context, namely a unified communications system approach to real-time communications systems. Various embodiments may also be applied, however, to other forms of real-time communications such as social media (e.g., Facebook, Twitter, etc.), interactive televisions, social gaming, contact center systems (CRMs), and the like.

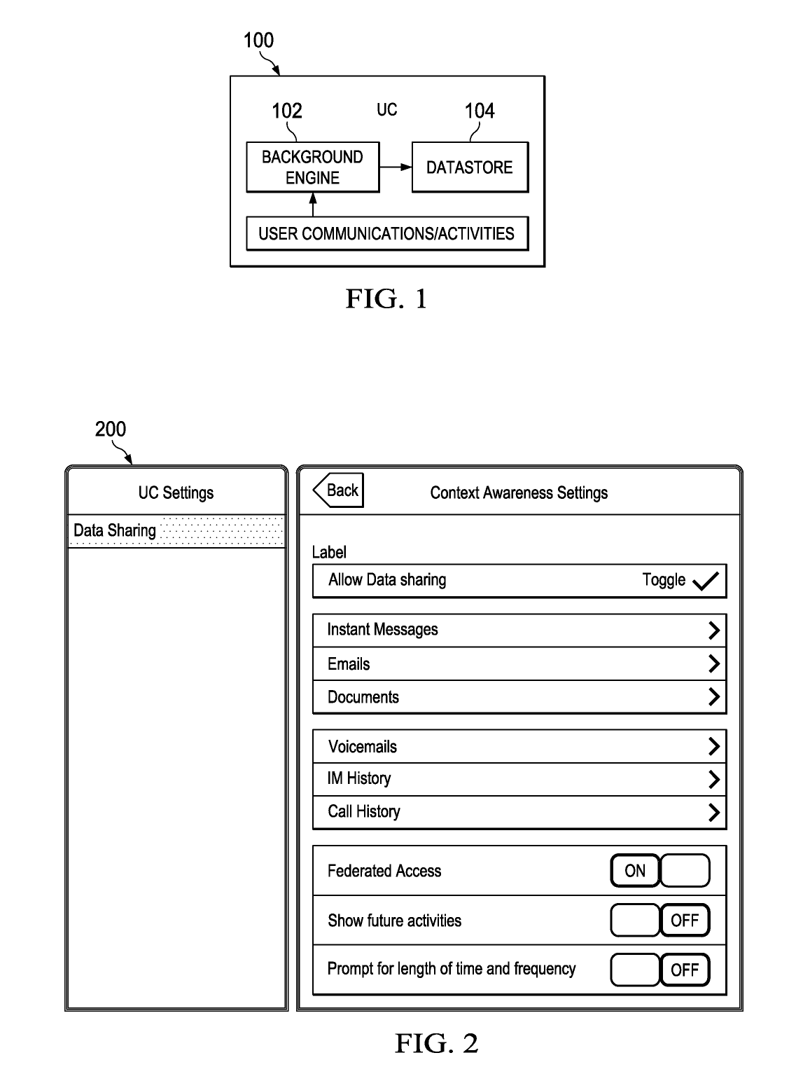

FIG. 1 illustrates a unified communication (UC) system 100. UC 100 includes a background engine 102 and a datastore 104. Datastore 104 may be implemented as a database in a cloud, a dedicated local drive, a shared drive in a network, and the like, although datastore 104 may be implemented as a different structure and/or in other places. Background engine 102 monitors a user's communications and activities across various mediums. For example, background engine 102 may monitor a user's e-mails, instant messages, documents, document history, voicemails, instant messaging history, call history, and/or activities calendar. Further, background engine 102 may monitor these activities across multiple UC devices (e.g., a laptop and a mobile phone) for a user. Thus background engine 102 is able to monitor a user's past (e.g., through sent/received emails), present (e.g., through documents the user is currently working on), and future (e.g., through calendar events) communications, activities, and in particular, interactions with other users.

Background engine 102 generates contexts for a user's communications and activities based on a monitored set of circumstances and/or facts regarding the communications and activities (e.g., the content, time, location, situation, and the like). Each context includes information regarding communications or activities related to a particular subject matter (e.g., a theme or topic). Communications/activities with the same context are grouped together based on the monitored set of circumstances/facts of the communication/activity itself. For example, background engine 102 monitors an email and determines it relates to context A based on the email's subject line. Background engine 102 also monitors a document and determines it also relates to context A based on the document's contents. Background engine 102 creates information in context A that indicates the document and email are related to context A. Context A, including this relationship information is stored in datastore 104. Each context contains relationship information linking past, present, and future communications/activities together. Varying contexts may also be distinguished based on time period even though the contexts may pertain to similar subject matters.

Each context also includes information on objects (e.g., an email, voicemail, a document, and the like) related to the context. This information on related objects is also derived from the monitored communications/activities. A context may include copies of related objects in datastore 104, or the context may contain reference links to the original object stored elsewhere.

Furthermore, each context also includes related user information for the context based on the monitored communications/activities. For example, background engine 102, working for user 1, determines that an email between user 1 and user 2 relates to context A. Background engine 102 stores information for context A indicating that user 2 is related to context A. Therefore, each context relates to a particular topic and includes information on past, present, and future communications, activities, objects and other users related to the topic. A communication/activity may be related to multiple contexts. For example, a call may be related to several different topics. All the relevant contexts related to a particular communication/activity include information relating to the communication/activity.

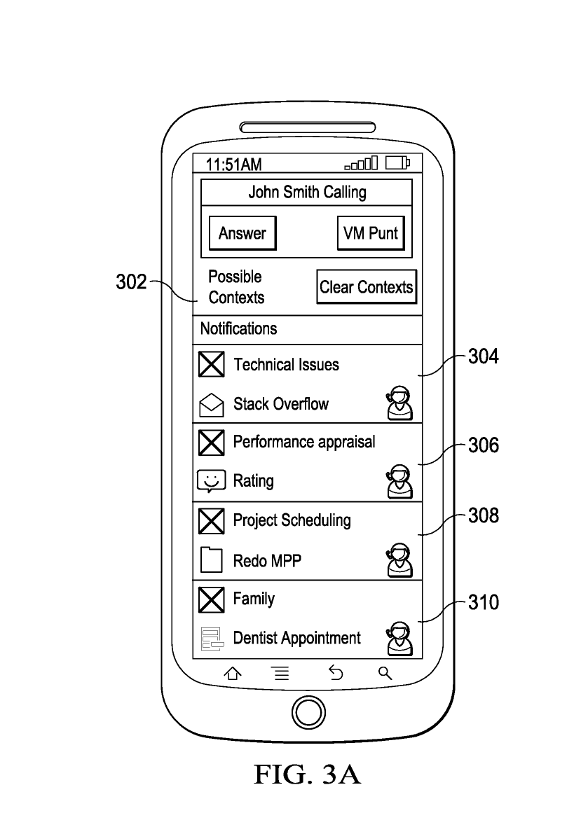

A user may select the forms of communications/activities the engine does or does not monitor. FIG. 2 illustrates an exemplary UC settings menu 200 allowing a user to choose the forms of communication/activity UC 100 should monitor. For example, the user may allow UC 100 to only monitor emails and voicemails. UC 100 may also be set to only monitor certain categories of communications with the Federated Access option (e.g., the user may allow UC 100 to only monitor work-related communications and not monitor personal communications). Furthermore, the user may be able to determine the time period and frequency in which UC 100 monitors communications/activities, and the user may also select specific groups of other users (e.g., select customers, partners, or vendors) to monitor.

When a user receives a real-time communication (e.g., a phone call or an instant message) from another user, UC 100 displays a list of possible contexts the communication may be related to. These possible contexts are derived from the information in the contexts stored in datastore 104. The list may be weighted so that the context with the highest probability of being relevant is displayed first, the context with the next highest probability is displayed second, and so on. The weighting of the list may be based on the frequency of a potential context (i.e., how often communications between the relevant users occurs), the freshness of a potential context (e.g., the last time activity between the relevant users occurred or the next time activity between the users is scheduled), the number of times the context has been labeled as important (e.g., flagged as important in an email, voicemail, etc.), the number of times other relevant users (e.g., users in the same team) have had communications about the context or a similar context, and the like. This weighted list may also be updated while the real-time communication takes place. For example, background engine 102 may determine a potential context has a higher probability of being relevant based on the monitored content of the real-time communication. Background engine 102 would then update the weighted list to reflect this determination. The user may choose which potential context in the list applies to the real time communication. Alternatively, as the real-time communication takes place, background engine 102 monitors the communication and determines the appropriate context.

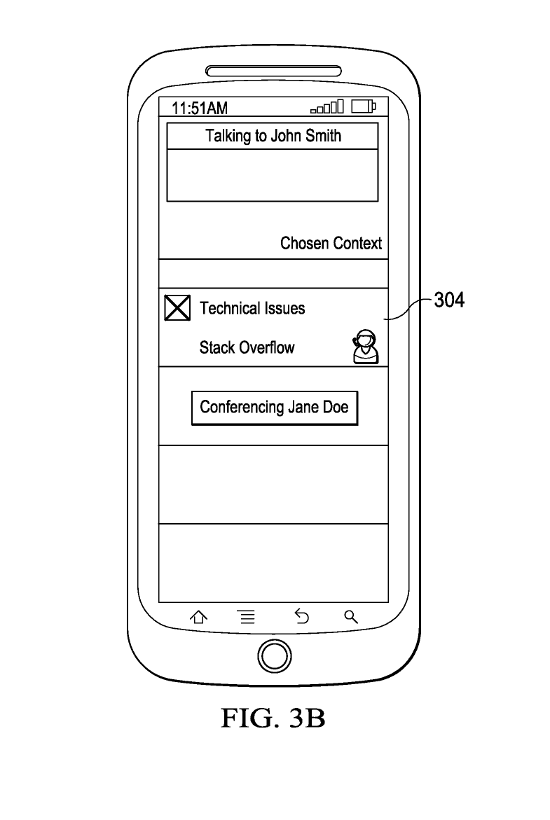

For example, FIG. 3A illustrates a possible screenshot of a user engaged in a real-time communication (a telephone call) with a second user, John Smith. A weighted list 302 of potential contexts 304-310 is displayed. These contexts are derived from various sources of monitored communications/activities between the user and John Smith. Context 304 (technical issues) is derived from an email, context 306 (performance appraisal) is derived from an instant message, context 308 (project scheduling) is derived from a document, and context 310 (family) is derived from the user's appointment calendar. The user may select the appropriate context from the list, or the context may be determined by UC 100 from monitored content of the call as it takes place. Weighted list 302 may also be displayed to John Smith. For example, John Smith may utilize a UC, similar to UC 100, to display weighted list 302. Alternatively, John Smith may use a social collaboration platform (e.g., Facebook), that allows weighted list 302 to be displayed.

Once the appropriate context of a real-time communication is determined, UC 100 may display other users that are related to the context. If the other users are brought into the real-time communication, the appropriate context is shared with them as well. For example, FIG. 3B shows that the appropriate context of the call between the user and John Smith is context 304 (technical issues). UC 100 displays an option to add another user, Jane Doe, to the call who also is related to context 304. UC 100 determines Jane Doe is related to context 304 based on the information about context 304 stored in datastore 104. If the user and/or John Smith decide to conference Jane Doe, context 304 is shared with her as well, so that she is immediately informed of the context (i.e., the subject matter) of the call.

Once an appropriate context is determined, UC 100 shares objects relevant to the context with all the users engaged in the real-time communication. Again, UC 100 knows which objects are relevant to a particular context based on the information stored in datastore 104. For example, FIG. 3C shows workspace 312 containing objects relevant to the appropriate context 304 (technical issues) of the conference call. The types of objects shared may include documents, emails, voicemails, instant message logs, other communiques, or the like relevant to context 304. Workspace 312 may be displayed where the list of potential contexts was previously displayed. Three users (the user, John Smith, and Jane Doe) are on the conference call. Workspace 312 is displayed to all three users automatically so that the relevant objects are shared with all three users. These shared documents may be the actual objects transferred to the relevant users or reference links to the objects stored in a commonly-accessible storage space (e.g., a shared drive or the cloud). The user may optionally disable object sharing through an option in UC 100s settings menu (see FIG. 2).

Following the real-time communication, the appropriate context is updated in datastore 104 to include the information from the communication. For example, after the conference call in FIGS. 3A-3C, background engine 102 would update context 304 in datastore 104 to include information about the call.

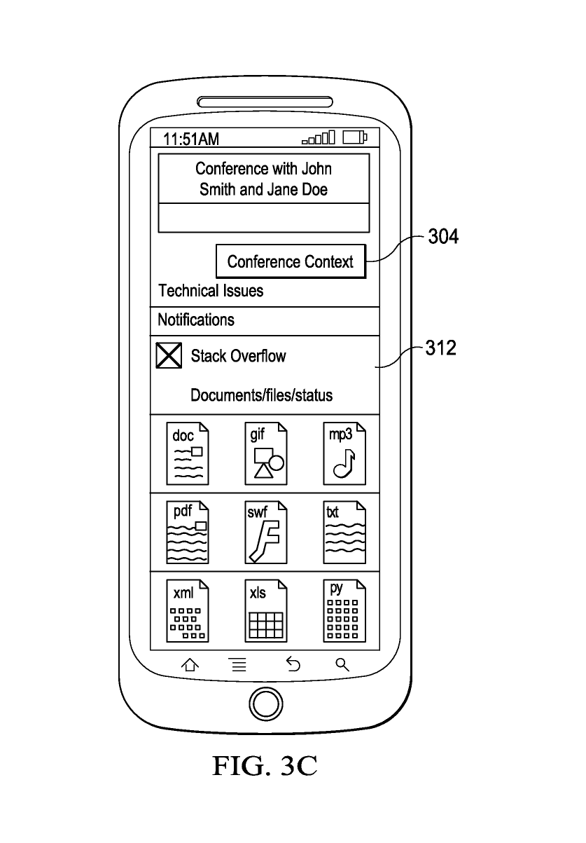

FIG. 4 shows a flow diagram illustrating UC activity in creating contexts. In step 402, the UC monitors a user's communications, activities, and documents. The user may choose the forms (e.g., email, voicemails, instant messages, etc.) and categories (e.g., personal, work, etc.) of communications/activities that are monitored. Based on the monitored set of circumstances or facts regarding these communications/activities (e.g., content), the UC creates contexts related to the subject matter of each communication/activity. Relationship information is included in each context regarding communications/activities, objects, and users related to the context. These contexts, including the relationship information, are stored in a datastore in step 406. Thus, the UC creates a datastore of contexts, wherein each context represents a particular subject matter and contains the user's communications, activities, objects, and interactions with other users.

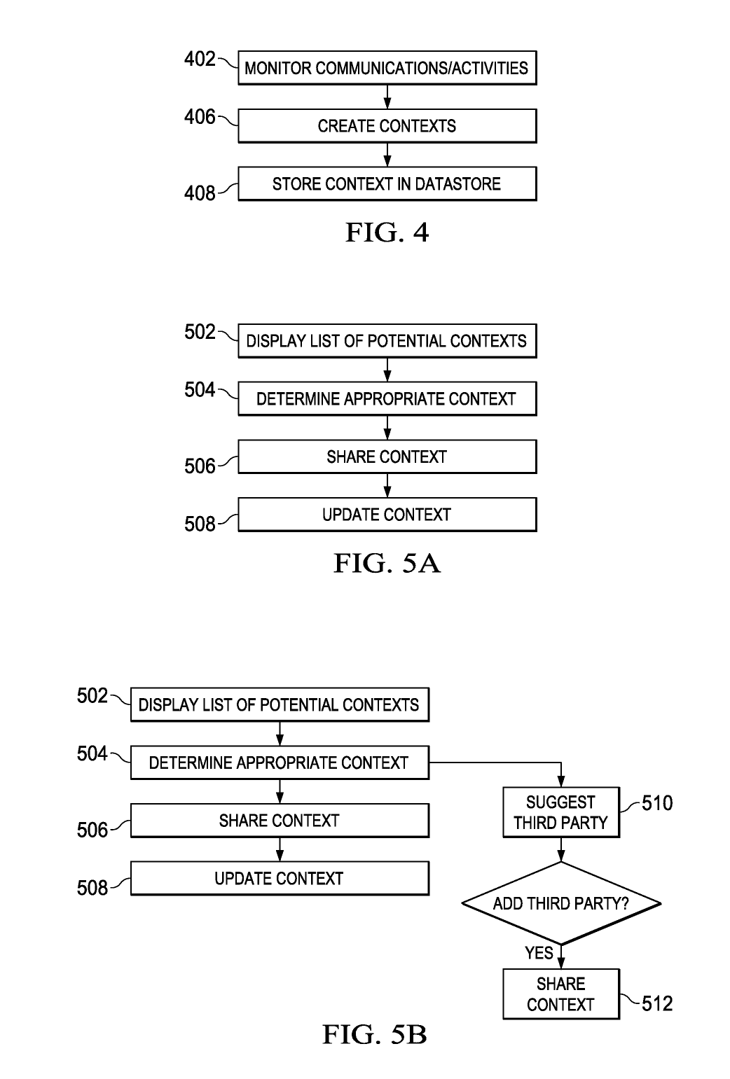

FIG. 5A shows a flow diagram illustrating UC activity during a real-time communication. A real-time communication is any communication between multiple users that occurs in real-time, such as a telephone call, a conference call or instant messaging chat session. In step 502, the UC displays a list of potential contexts between the users involved in a real-time communication. This list of potential contexts is created based on the stored information in each context regarding user interaction. This potential context list may be weighted so that the contexts are displayed in descending order of likely relevancy (i.e., the most likely context is displayed first, etc.). The likelihood of any context being relevant is determined by the UC based on the stored information regarding monitored interactions between the users. The order potential contexts are displayed may be updated as the UC monitors the content of the real-time communication.

In step 504, an appropriate context for the real-time communication is determined. The appropriate context may be selected manually by the user from the list of potential contexts. Alternatively, the appropriate context may be determined by UC 100 automatically based on the monitored content of the real-time communication.

In step 506, the UC shares the context, including relevant objects, with all the users on the communication. The UC determines which objects are relevant based on the context's stored information. The UC may share these objects by physically transferring the objects to each user. Alternatively, the UC may simply share referential links to the objects stored in a commonly accessible space (e.g., a shared drive or a cloud).

In step 508, the UC updates the appropriate context with information about the communication. For example, if new users (i.e., users that were previously uninvolved with the context) were on the call, the UC would update the context to include information on the new users.

In an alternative embodiment, illustrated in FIG. 5B, after the appropriate context is determined, then in step 510, the UC suggests third party users (i.e., users not currently in the communication) that may be related to the context. If the users in the real-time communication decide to add the third party users, then, in step 512, the appropriate context and relevant documents are shared with the third party user as well.

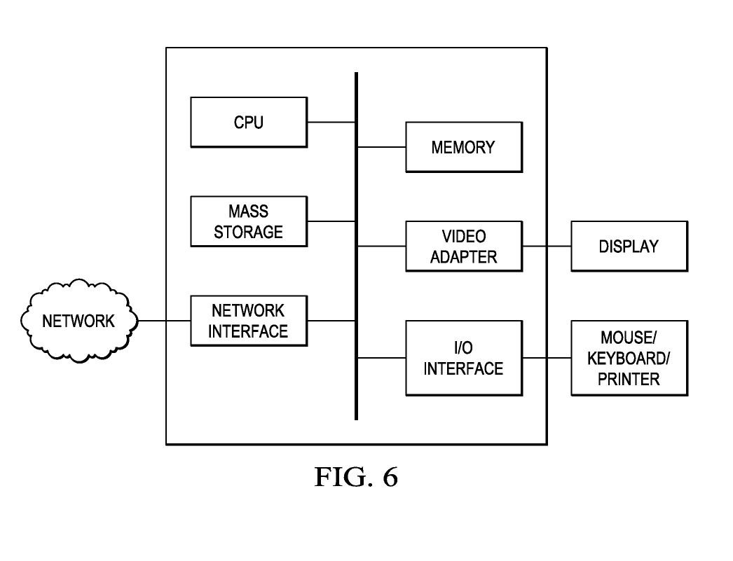

FIG. 6 is a block diagram of a processing system that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system may comprise a processing unit equipped with one or more input/output devices, such as a speaker, microphone, mouse, touchscreen, keypad, keyboard, printer, display, and the like. The processing unit may include a central processing unit (CPU), memory, a mass storage device, a video adapter, and an I/O interface connected to a bus.

The bus may be one or more of any type of several bus architectures including a memory bus or memory controller, a peripheral bus, video bus, or the like. The CPU may comprise any type of electronic data processor. The memory may comprise any type of system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for program and data storage for use while executing programs.

The mass storage device may comprise any type of storage device configured to store data, programs, and other information and to make the data, programs, and other information accessible via the bus. The mass storage device may comprise, for example, one or more of a solid state drive, hard disk drive, a magnetic disk drive, an optical disk drive, or the like.

The video adapter and the I/O interface provide interfaces to couple external input and output devices to the processing unit. As illustrated, examples of input and output devices include the display coupled to the video adapter and the mouse/keyboard/printer coupled to the I/O interface. Other devices may be coupled to the processing unit, and additional or fewer interface cards may be utilized. For example, a serial interface card (not shown) may be used to provide a serial interface for a printer.

The processing unit also includes one or more network interfaces, which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for conducting real-time communications comprising:
creating, by a processor, a plurality of contexts for a first user;
creating a list of potential contexts in accordance with the plurality of contexts when the first user and a second user engage in a real-time communication; and
displaying the list of potential contexts to the first user.

2. The method of claim 1, further comprising storing the plurality of contexts in a datastore.

3. The method of claim 1, further comprising:
determining an appropriate context of the real-time communication, wherein the appropriate context includes information on one or more objects related to the appropriate context; and
sharing the appropriate context with a group of users engaged in the real-time communication, wherein the group of users includes the first and the second user.

4. The method of claim 3, further comprising after determining an appropriate context:
suggesting, by the processor, a third user related to the appropriate context to join the real-time communication, wherein the group of users does not include the third user; and
sharing the appropriate context with the third user when the third user joins the real-time communication.

5. The method of claim 3, wherein determining the appropriate context comprises the first user selecting the appropriate context from the list of potential contexts.

6. The method of claim 3, wherein determining the appropriate context comprises:
monitoring, by the processor, contents of the real-time communication; and
selecting, by the processor, the appropriate context from the list of potential contexts based the content of the real-time communication.

7. The method of claim 1, wherein creating the plurality of contexts comprises:
monitoring, by the processor, contents of a plurality of communications or activities of the first user; and
generating multiple of contexts in accordance with the contents of the plurality of communications or activities by:
determining one or more contexts for each of the plurality of communications or activities; and
including, in the one or more contexts, information on: communications, activities, or a combination thereof relating to the context, one or more objects relating to the context, and other users related to the context.

8. The method of claim 7, further comprising allowing the first user to select types of communications or activities included in the plurality of communications or activities.

9. The method of claim 1, wherein creating a list of potential contexts comprises creating a weighted list of potential contexts based on a likelihood each potential context in the weighted list is an appropriate context of the real-time communication.

10. A method for real-time communications comprising:
creating, by a processor, a datastore of contexts for a first user, wherein each context in the datastore includes information on communications, activities, or a combination thereof related to the context, information on one or more objects related to the context, and information on other users related to the context;
generating a list of possible contexts when the first user and a second user engage in a real-time communication based on the datastore of contexts;
displaying the list of possible contexts to the first user;
determining an applicable context for real-time communication from the list of possible contexts; and
sharing the applicable context with the first and the second user.

11. The method of claim 10, wherein generating a list of possible contexts comprises generating a weighted list of possible contexts in accordance with a probability a possible context in the list is the applicable context.

12. The method of claim 11, further comprising, before determining an appropriate context, generating an updated weighted list of possible contexts based on monitored content of the real-time communication, and displaying the updated weighted list of possible contexts.

13. A unified communications (UC) device comprising:
a processor; and
a computer readable storage medium storing programming for execution by the processor, the programming including instructions to:
create a datastore of contexts for a first user;
generate a list of possible contexts when the first user and a second user engage in a real-time communication based on the datastore of contexts;
display the list of possible contexts to the first user;
determine an applicable context for the real-time communication from the list of possible contexts; and
share the applicable context with the first and the second user.

14. The UC of claim 13, wherein each context in the datastore includes relationship information on communications, activities, or a combination thereof related to the context, information on one or more objects related to the context, and information on other users related to the context.

15. The UC of claim 14, wherein the information on one or more objects related to the context includes one or more reference links to the one or more objects.

16. The UC of claim 13, wherein the list of possible contexts is a weighted list of possible contexts ordered by a likelihood a possible context in the list is the applicable context for the real-time communication.

17. The UC of claim 13, wherein the datastore is implemented in a cloud, a shared drive, a dedicated local drive, or a combination thereof.

18. The UC of claim 13, wherein the instructions to create a datastore of contexts include further instructions to:
monitor contents of a multitude of communications or activities of the first user;
generate a plurality of contexts based on the contents of the multitude of communications or activities by determining a context for each of the multitude of communications or activities and including, in the context, information on communications, activities, or a combination thereof relating to the context, one or more objects relating to the context, and other users related to the context; and
store the plurality of contexts in a datastore.

19. The UC of claim 18, wherein the multitude of communications or activities comprises one or more emails, instant messages, documents, document histories, voicemails, instant messaging histories, call histories, calendar activities, or a combination thereof.

20. The UC of claim 13, wherein the program includes further instructions to suggest a third user related to the applicable context to join the real-time communication, wherein the third user is not engaged in the real-time communication.

21. The UC of claim 13, wherein the program includes further instructions to share the applicable context with a third user when the third user engages in the real-time communication.
